(19) United States
(12) Patent Application Publication
(10) Pub. No.: US 2003/0079137 A1
(43) Pub. Date: Apr. 24, 2003

(54) System and method of identifying sender of mail

(76) Inventor: Clifford H. Kraft, Naperville, IL (US)

Correspondence Address: Clifford Kraft, 320 Robin Hills Dr., Naperville, IL, 60540, US

(21) Appl. No.: 09/999,630

(22) Filed: Oct. 24, 2001

(51) Int. Cl. H04L 9/00

(52) U.S. Cl. 713/186; 380/51

(57) ABSTRACT

A system and method for identifying who sent a particular piece of mail or parcel. A positive identification is made of anybody trying to mail a letter or parcel (or send something by any other means) using digital techniques such as fingerprint scan, retinal scan, face scan, DNA or any other positive ID technique. An optional photo can be taken of the sender. The positive identification information and photo is then attached to the item to be sent after the item is out of the control of the sender. The data can be attached by microdot, magnetic strip, ink spray, barcode, or by any other means of attaching digital data to an item. The sidewalk mailbox is replaces with a remote mail station. Positive ID would be a prerequisite for mailing any letter.

### BACKGROUND

1. Field of the Invention

The present invention relates to the field of security and more particularly to a system and method for identifying the sender of a piece of mail or other shipment.

2. Description of Related Art

At present, there is no good way to determine who mailed a letter or package and from exactly where it was mailed. There have been numerous instances where law enforcement officials and postal inspectors would very much like to identify the person who mailed a particular letter or package (for example, the case of the notorious Unibomber as well as letters containing Anthrax).

The return address on a letter means absolutely nothing because a sender can put anything there as well as nothing. The postmark of course identifies the post office that first processed the letter or parcel, but it does not identify where it was mailed (a letter may have been dropped into any sidewalk box). What is badly needed is a system and method where a letter or parcel can later be traced to a particular person who mailed it.

### SUMMARY OF THE INVENTION

The present invention relates to a way to put positive identification of the sender on any letter, envelope, or parcel in a way that the sender cannot alter or control.

The invention comprises automatic personal identification known in the art coupled with coding, micro-dot, or any other marking means. The current methods of mailing letters are replaced with two new methods. First, at the post office, positive ID is placed on the item after it leaves the sender's hands; second, the corner mailbox is replace with an automatic mailing station where positive ID is again placed on the item after it leaves the sender's hands.

Automatic personal identification can today be accomplished through fingerprinting, face feature scan, retinal scan, DNA, and other techniques. By personal identification, I mean any of these techniques or any other techniques that might be developed in the future to positively identify a particular individual.

The present invention causes a positive personal identification to be performed on a postal, UPS, FEDEX, freight, or any other customer who submits any item be it postage, parcel or otherwise for transportation. While the invention is particularly useful for mail, it can be used for any other type of movement of items.

The system is either installed at a post office or receiving office, or it is located as part of an automatic remote mailing center that will replace sidewalk mailboxes. In either case, the sender approaches the system and goes through a positive ID process. The most common and preferred method is to have the person place their finger on an automatic fingerprint device that makes an electronic copy of their fingerprint. At the same time, an optional photograph of the sender can be taken. As has been stated, any other positive ID method is within the scope of the present invention.

The ID is then digitally formatted, possibly compressed to reduce the amount of binary storage required, and finally, and unremovably placed on the actual letter or parcel. The system could also optionally record the information; however, this is not necessary and may not be practical due to the large volume of mail.

Many techniques are known in the art for coding and placing large amounts of binary data onto paper. Among these techniques are photographic or ink microdots, bar codes, and numerous other types of codes. The key to the present invention is that digital information positively identifying the sender of the letter or parcel is put onto the letter or parcel itself after it has left control of the sender. Thus, in one embodiment of the present invention, a digital record of the sender's fingerprint and a compressed digital photo of the sender are coded and placed in a micro-dot or are inked onto a very small area on the envelope or package. In addition, the location of the dispatch, and the date and time are also included.

Later, if law enforcement officials have any question about who sent a particular letter or parcel, complete and unforgeable or changeable information as to the positive identity of the sender as well as the location, date, and time of the dispatch can be read from the coded dot or mark.

### DESCRIPTION OF THE FIGURES

FIG. 1 shows a post office or remote mail receiving station from the side.

FIG. 2 shows the same station from the front.

FIG. 3 shows a letter with a microdot near the postage stamp.

FIG. 4 shows a letter with a micro barcode near the postage stamp.

FIG. 5 shows a flowchart of the method of the present invention.

### DESCRIPTION OF THE INVENTION

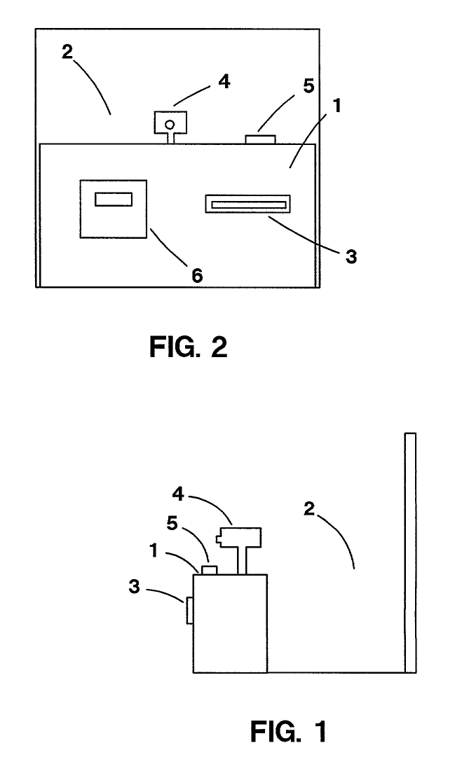

Turning to FIG. 1, a side view of a postal (or UPS, etc.) receiving station is shown. This can be located in a post office or other office or can be a remote mail receiving station replacing the current sidewalk mailbox.

FIG. 2 shows a front view of the same station.

The receiving station of FIGS. 1-2 has a front counter 1 and an area behind the counter 2 for a clerk in the case of a post office. On the counter is a device for identification 5, such as an electronic fingerprint sensor, and a camera 4. In addition, there is a slot 3 or other means of receiving smaller mail or items, and a larger box 6 for receiving larger items.

The process is as follows: The sender approaches the counter 1 and places the letter or item to be sent in either the letter slot 3, or the package receptacle 6. If there is a live clerk, that person can alternatively take the item(s) from the sender. After the item is out of the control of the sender, the sender is required to place a finger on the fingerprint sensor 5, or have their face scanned, or take part in any other form of positive identification. An optional photograph can be taken with the camera 5.

The system then quickly codes the fingerprint or other digital ID information as well as the photograph and prepares this data to be put permanently onto the item being sent.

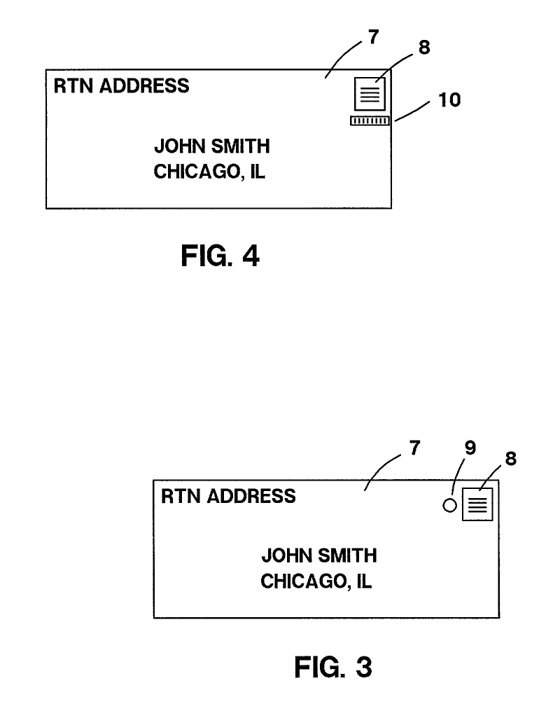

FIGS. 3 and 4 show standard letters 7 that are being mailed.

They contain the usual postage stamp, meter mark or other mark to pay for postage, and they contain somewhere (anywhere) on the item, a dot 9 or mark 10 that contains the digital ID information as well as the location code of the sending location and the time and date.

Digital coding and digital compression are well known in the art as are micro-dots, micro-writing, ink bar coding and many other ways of placing digital information on an item. It is within the scope of the present invention to also place the information on a magnetic strip, a silicon chip, or on any other digital storage means. Any means of putting digital information on an item that now exist or may be developed are within the scope of the present invention. This also includes any magnetic method such as a magnetic strip.

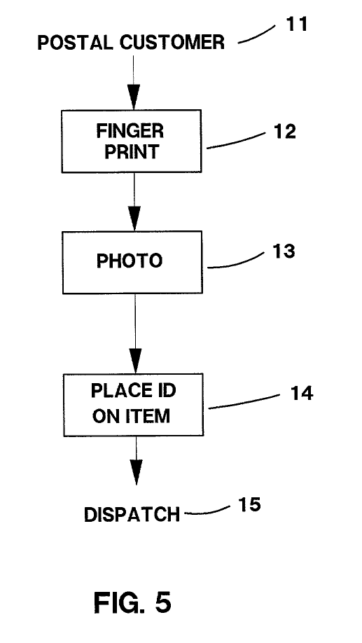

FIG. 5 shows the method and process. A postal customer 11 approaches the counter and places an item (such as a letter) to be dispatched into a slot or compartment. A positive ID 12 is then made of the customer such as an electronic fingerprint scan. An optional photo 13 is taken, and all the digital information is coded and optionally compressed. The compressed data can also contain error correcting or detecting codes known in the art. The compressed data is then placed on the item to be displaced 14 in a way that it cannot be changed or removed, and in a way that it is completely out of the control of the sender. The sender cannot retrieve the item at that point. Finally, after the digital data has been attached to the item, the item is dispatched 15.

An embodiment of the present invention is a sidewalk remote mail receiving station where the sender must place a bare finger on the a fingerprint or other positive identification sensor for the process to continue. If for some reason, the sender refuses to do this (or refuses to remove gloves, etc.), the system can optionally hold the item or letter without returning it to the sender. The system can also take a digital photo of the sender to be included with the digital identification data.

In any of the previous embodiments, the positive identification data, once obtained, can be checked against a law enforcement data base. The item to be sent could be held if there is law enforcement interest, and/or an alarm, possibly silent, could be sent to law enforcement.

It should be understood that the embodiments described are for illustration only. Numerous variations and changes that would be apparent to those skilled in the art are within the scope of the present invention.

I claim:

1. A method of identifying the sender of an item comprising:
performing a positive identification of said sender, said identification resulting in identification data;
attaching said identification data on said item after said item is out of control of said sender.

2. The method of claim 1 wherein said positive identification is a digital fingerprint.

3. The method of claim 1 wherein said positive identification is a face scan.

4. The method of claim 1 wherein said positive identification is retinal scan.

5. The method of claim 1 wherein said positive identification is with DNA.

6. The method of claim 1 further comprising including a digital photo of said sender in said data.

7. The method of claim 1 wherein said method of attaching said data to said item is with a microdot.

8. The method of claim 1 wherein said method of attaching said data to said item is with a magnetic means.

9. The method of claim 9 wherein said magnetic means is a magnetic strip.

10. The method of claim 1 wherein said method of attaching said data to said item is with ink.

11. The method of claim 1 wherein said method of attaching said data to said item is with a barcode.

12. A remote item receiving station comprising:
an item receiving slot for receiving an item to be dispatched;
a means for positive identification of a sender, said means for positive identification producing digital identification data;
a means for attaching said digital identification data on said item to be dispatched after said item leaves control of said sender.

13. The remote item receiving station of claim 12 wherein said means for positive identification is a fingerprint scanner.

14. The remote item receiving station of claim 12 wherein said means for positive identification is a face scan.

15. The remote item receiving station of claim 12 wherein said means for attaching said identification data on said item is a microdot.

16. The remote item receiving station of claim 12 wherein said means for attaching said identification data on said item is magnetic.

17. The remote item receiving station of claim 16 wherein said magnetic means is a magnetic strip.

18. The remote item receiving station of claim 12 further comprising a camera, said cameral forming a digital photo of said sender, said digital photo also being placed on said item.

19. A remote postal mail receiving station to be located on sidewalks and in buildings to replace sidewalk mailboxes where senders mail letters, the remote postal mail receiving station comprising: a receptacle to receive letters; a digital fingerprint scanner; a camera, said sender being required to place a finger on said fingerprint scanner in order to dispatch said letter, said fingerprint scanner forming a digital fingerprint of said sender, said camera taking a digital photo of said sender, said digital fingerprint and said digital photo being placed on said letter after said letter leaves control of said sender.

20. The remote postal mail receiving station further comprising means of retaining said letter and not dispatching said letter in a case where said sender does not permit said fingerprint or positive identification identifies said sender as having law enforcement interest.
